(19) United States
(12) Patent Application Publication
(10) Pub. No.: US 2018/0328447 A1
(43) Pub. Date: Nov. 15, 2018

(54) Torsional Vibration Damping Arrangement Having A Phase Shifter And A Magnetic Gear For The Powertrain Of A Vehicle

(71) Applicant: ZF FRIEDRICHSHAFEN AG, Friedrichshafen (DE)

(72) Inventors: Tobias DIECKHOFF, Wuerzburg (DE); Matthis FISCHER, Oerlenbach (DE); Reinhard FELDHAUS, Euerbach (DE)

(73) Assignee: ZF FRIEDRICHSHAFEN AG, Friedrichshafen (DE)

(21) Appl. No.: 15/773,277

(22) PCT Filed: Oct. 5, 2016
(86) PCT No.: PCT/EP2016/073718

§ 371 Date: May 3, 2018

(30) Foreign Application Priority Data
Nov. 6, 2015 (DE) 10 2015 221 893.7

(51) Int. Cl. F16F 15/131; H02K 49/10

(52) U.S. Cl. CPC F16F 15/13157; H02K 49/102

(57) ABSTRACT

A torsional vibration damping arrangement for the powertrain of a vehicle includes an input region to be driven for rotation around a rotational axis (A) and an output region, there being provided between the input region and the output region a first torque transmission path and, parallel thereto, a second torque transmission path and a coupling arrangement. A phase shifter arrangement is provided in the first torque transmission path. The coupling arrangement is constructed as a magnetic coupling gear unit.

### PRIORITY CLAIM

This is a U.S. national stage of application No. PCT/EP2016/073718, filed on Oct. 5, 2016. Priority is claimed on the following application: Country: Germany, Application No.: 10 2015 221 893.7, Filed: Nov. 6, 2015; the content of which is/are incorporated in its entirety herein by reference.

### BACKGROUND OF THE INVENTION

The present invention is directed to a torsional vibration damping arrangement for the powertrain of a vehicle, comprising an input region to be driven for rotation around a rotational axis and comprising an output region, there being provided between the input region and the output region a first torque transmission path and, parallel thereto, a second torque transmission path and a coupling arrangement for superimposing the torques conducted via the torque transmission paths, wherein a phase shifter arrangement is provided in the first torque transmission path for generating a phase shift of rotational irregularities conducted via the first torque transmission path in relation to rotational irregularities conducted via the second torque transmission path.

German Patent Application DE 10 2011 007 118 A1, the entire disclosure of which is hereby incorporated herein by reference, discloses a torsional vibration damping arrangement which divides the torque introduced into an input region, for example, through a crankshaft of an internal combustion engine, into a torque component transmitted via a first torque transmission path and into a torque component conducted via a second torque transmission path. When the torque is divided in this way, not only is a static torque divided, but the vibrations or rotational irregularities which are contained in the torque to be transmitted and which are generated, for example, through the periodically occurring ignitions in an internal combustion engine are also distributed proportionally to the two torque transmission paths. The coupling arrangement in this case brings the two torque transmission paths together again and guides the combined total torque into the output region, for example, a friction clutch or the like.

A phase shifter arrangement is provided in at least one of the torque transmission paths and is constructed in the manner of a vibration damper, i.e., with a primary element and a secondary element which is rotatable relative to the primary element owing to the compressibility of a spring arrangement. A phase shift of up to 180° occurs in particular when this vibration system passes into a supercritical state, i.e., is excited by vibrations which lie above the resonant frequency of the vibration system. This means that with a maximum phase shift the vibration components delivered by the vibration system are shifted in phase by 180° with respect to the vibration components received by the vibration system. Since the vibration components guided via the other torque transmission path do not undergo a phase shift or, if so, a different phase shift, the vibration components which are contained in the combined torque and which are then shifted in phase relative to one another can be destructively superposed one upon the other so that, ideally, the total torque guided into the output region is a substantially static torque which does not contain any vibration components.

### SUMMARY OF THE INVENTION

It is an object of the present invention to provide a torsional vibration damping arrangement which has an improved vibration damping behavior in a simple construction. According to the invention, this object is met by a torsional vibration damping arrangement for a powertrain of a vehicle, comprising an input region to be driven for rotation around a rotational axis (A) and an output region, wherein there are provided parallel to one another between the input region and the output region a first torque transmission path for transmitting a first torque component of a total torque to be transmitted between the input region and the output region and a second torque transmission path for transmitting a second torque component of a total torque to be transmitted between the input region and the output region, a phase shifter arrangement at least in the first torque transmission path for generating a phase shift of rotational irregularities conducted via the first torque transmission path in relation to rotational irregularities conducted via the second torque transmission path, wherein the phase shifter arrangement comprises a vibration system with a primary element and a secondary element which is rotatable relative to the primary element around the rotational axis (A) against the restoring action of a damper element arrangement, and a coupling arrangement for combining the first torque component transmitted via the first torque transmission path and the second torque component transmitted via the second torque transmission path and for routing the combined torque to the output region, wherein the coupling arrangement comprises a first input element connected to the first torque transmission path, a second input element connected to the second torque transmission path, and an output element connected to the output region, wherein the coupling arrangement is constructed as a magnetic coupling gear unit. The functioning of the magnetic coupling gear unit, which may also be referred to as a magnetic gear unit, is comparable to that of a known planetary gear unit. The magnetic coupling gear unit includes an external rotor which has on its inner side permanent magnets which alternately have a magnetic north polarity and magnetic south polarity. An internal rotor which likewise has permanent magnets with alternating polarity is arranged radially inside of the external rotor.

A modulator ring alternately having a ferromagnetic segment and a nonmagnetic segment is located radially between the two rotors or magnet arrangements.

In a practical implementation, it is advantageous primarily for reasons of strength that the ferromagnetic elements of the modulator ring are embedded in a closed supporting construction. The fastening of the permanent magnets to the rotors is also known and need not be discussed further.

Magnetic fields are generated in each instance by the magnet arrangements at the external rotor and internal rotor. The quantity of magnets in the two arrangements is to be coordinated in such a way that the magnetic fields do not mutually influence one another without the modulator ring. However, as a result of the quantity and arrangement of the ferromagnetic segments of the modulator ring, the magnetic fields are modulated such that a magnetic coupling occurs between the internal rotor and the external rotor.

The mathematical-physical relationships for determining the required quantity of magnet pairs at the internal rotor and external rotor and ferromagnetic elements of the modulator ring are known in the art and need not be discussed further. However, it should be noted that a large range of gear ratios is possible between the three gear unit elements as a result of an appropriate configuration, that this is determined only by the ratios of the quantity of magnet pairs and modulator segments and that, for each quantity of pole pairs of the two rotors, two different numbers of modulator segments are possible by which a different rotational direction of the modulator ring is achieved with respect to one of the other rotors.

With respect to its basic functioning, the operation of a gear unit of this type is similar to that of a planetary gear unit. Accordingly, it is also possible to use it as a coupling arrangement for torsional vibration mitigation with two torque transmission paths.

When using the magnetic gear unit as coupling arrangement, also known as magnetic coupling gear unit, it can be particularly advantageous because the gear unit can be operated free of lubricant, the gear unit elements do not touch one another and, consequently, operate without wear and without noise except for the bearing noise, and the magnetic gear unit is safeguarded against overload because it merely slips without sustaining damage when a maximum torque is exceeded.

Further, with a magnetic gear unit, gear ratios between the individual rotors can be adjusted very flexibly. In this respect, the gear ratio is independent of the radii of the gear unit elements. Also, the rotational direction of the modulator ring can be freely adjusted with respect to the rotors which also allows a greater number of connection variants in the powertrain with two torque transmission paths.

A further advantageous embodiment provides that the magnetic coupling gear unit includes an external rotor, an internal rotor arranged concentric to the external rotor, and a modulator ring which is arranged concentrically radially between the external rotor and the internal rotor, and the external rotor, internal rotor and modulator ring are arranged so as to at least partially axially overlap one another. In order to make advantageous use of the magnetic forces between the external rotor, internal rotor and modulator ring it is advantageous when they completely overlap one another in axial direction. In this case, neither the external rotor nor the internal rotor is in contact with the modulator ring. On the contrary, there is a slight air gap between them.

In a further embodiment, the external rotor comprises permanent magnets which have a magnetic north polarity and a magnetic south polarity alternately in circumferential direction, or the external rotor is formed at its radially inner side with permanent magnets which have a magnetic north polarity and a magnetic south polarity alternately in circumferential direction. A support element in the form of a support ring is advantageously provided for receiving the permanent magnets which are cemented to it or fastened in a comparable manner. This is particularly advantageous for the strength of the external rotor.

In a further embodiment, it is provided that the internal rotor comprises permanent magnets which have a magnetic north polarity and a magnetic south polarity alternately in circumferential direction, or that the internal rotor is formed at its radially outer side with permanent magnets which have a magnetic north polarity and a magnetic south polarity alternately in circumferential direction. A support element in the form of a support ring is advantageously provided for receiving the permanent magnets which are cemented to it or fastened in a comparable manner. This is particularly advantageous for the strength of the internal rotor.

In a further advantageous configuration, the modulator ring comprises ferromagnetic segments and nonmagnetic segments which are arranged alternately in circumferential direction.

A further advantageous embodiment provides that the external rotor is connected to the first input element and that the internal rotor is connected to the second input element and that the modulator ring is connected to the output element. This is particularly advantageous because, in this embodiment, a high mass moment of inertia of the external rotor is linked to the secondary element of the phase shifter arrangement, which benefits the operation of the phase shifter in a supercritical range and therefore positively affects a phase shift.

In a further constructional variant, the external rotor is connected to the second input element, and the modulator ring is connected to the first input element, and the internal rotor is connected to the output element.

In a further advantageous variant, it is provided that the external rotor is connected to the second input element and that the modulator ring is connected to the output element and that the internal rotor is connected to the first input element.

It can also be provided in a further constructional variant that the external rotor is connected to the output element and that the modulator ring is connected to the first input element and that the internal rotor is connected to the second input element.

It may also be advantageous when the external rotor is connected to the output element, and the modulator ring is connected to the second input element, and the internal rotor is connected to the first input element.

In a further advantageous embodiment, it is provided that the external rotor and the modulator ring and the internal rotor are rotatably supported at a shaft which is concentric to the rotational axis (A) and communicates with the input region. This form of bearing support is particularly advantageous because all of the component parts of the magnetic gear unit are supported at a common shaft. Accordingly, an air gap running around the rotational axis A between the external rotor and the modulator ring and between the modulator ring and the internal rotor can be kept small because no misalignment or offset occurs in this case. In concrete terms, this means that all of the component parts of the magnetic coupling gear unit are radially supported on the input side which is formed, for example, by the crankshaft.

In a further configuration, it is provided that the external rotor and the modulator ring and the internal rotor are rotatably supported at a shaft which is concentric to the rotational axis (A) and communicates with the output region. Therefore, again, an air gap running around the rotational axis A between the external rotor and the modulator ring and between the modulator ring and the internal rotor can be kept small because no misalignment or offset occurs in this case. In concrete terms, this means that all of the component parts of the magnetic coupling gear unit are radially supported on the output side, for example, by means of the transmission input shaft.

In a further configuration, it is provided that at least the external rotor or the modulator ring or the internal rotor is rotatably supported at a shaft which is concentric to the rotational axis (A) and which communicates with the input region, and that at least the external rotor or the modulator ring or the internal rotor is rotatably supported at a shaft which is concentric to the rotational axis (A) and which communicates with the output region. In this way, the radial bearing support of the magnetic coupling gear unit is divided between the input side, for example, the crankshaft, and the output side, for example, the transmission input shaft. This can be advantageous with respect to the space requirement of the radial bearing support when the latter is divided between two regions.

### BRIEF DESCRIPTION OF THE DRAWINGS

The present invention will be described in more detail in the following with reference to the accompanying figures in which:

FIG. 1 is a schematic view of the torsional vibration damping arrangement in which the torque transmission path is divided into two torque transmission paths and with a magnetic coupling gear unit as coupling arrangement;

FIG. 2 is a constructional layout of a magnetic coupling gear unit;

FIGS. 3-7 are different connection variants of the magnetic coupling gear unit in the torsional vibration damping arrangement; and

FIG. 8 shows a bearing variant of the magnetic coupling gear unit.

### DETAILED DESCRIPTION OF THE PRESENTLY PREFERRED EMBODIMENTS

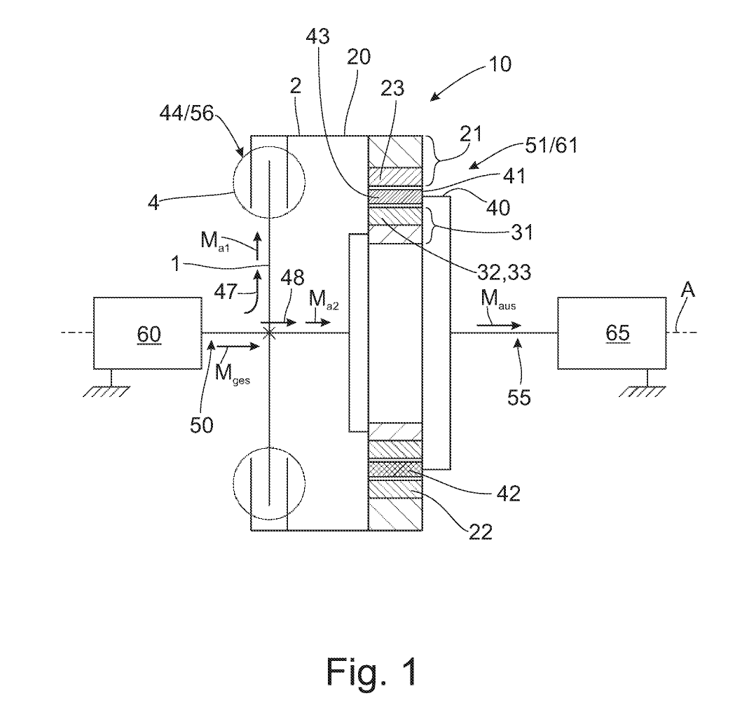

A first embodiment of a torsional vibration damping arrangement, designated in its entirety by 10, which operates according to the principle of power splitting or torque splitting will be described in the following referring to FIG. 1. The torsional vibration damping arrangement 10 can be arranged in a powertrain, e.g., in a vehicle, between a drive unit, i.e., for example, an internal combustion engine, and the following portion of the powertrain, i.e., for example, a friction clutch, a hydrodynamic torque converter or the like.

The torsional vibration damping arrangement 10 shown schematically in FIG. 1 comprises an input region, designated in its entirety by 50. This input region 50 can be connected to a crankshaft of a drive unit 60, for example, by screwing. In the input region 50, the torque received from a drive unit branches into a first torque transmission path 47 and a second torque transmission path 48. In the region of a coupling arrangement, designated in its entirety by 51, the torque components Mₐ₁ and Mₐ₂ conducted via the two torque transmission paths 47, 48 are combined again to form an output torque Mₐᵤₛ and then routed to an output region 55, for example, as in this case, a transmission 65.

A vibration system, designated in its entirety by 56, is integrated in the first torque transmission path 47. The vibration system 56 acts as a phase shifter arrangement 44 and comprises a primary element 1 to be connected to a drive unit, for example, an internal combustion engine and a secondary element 2 which further guides the torque. The primary element 1 is rotatable against a damper element arrangement 4 relative to the secondary element 2.

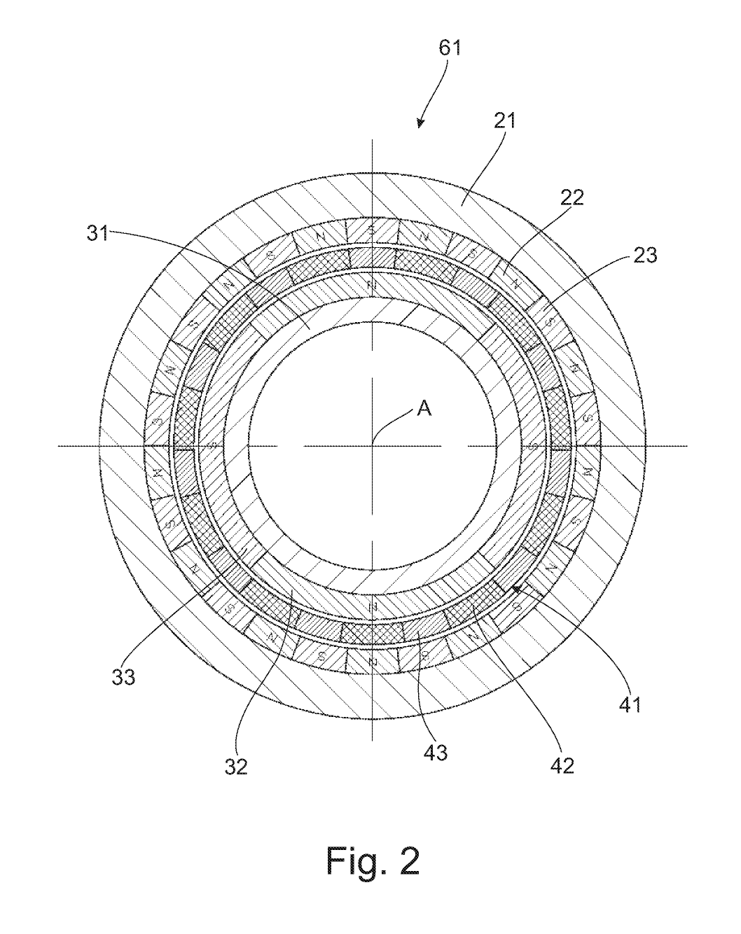

It will be appreciated from the preceding description that the vibration system 56 is constructed in the manner of a torsional vibration damper with one or more spring sets. Through a choice of masses of the primary element 1 and of the secondary element 2 and a choice of stiffnesses of the spring set or spring sets, it is possible to set the resonant frequency of the vibration system 56 in a desired range in order to achieve a favorable phase shift of torsional vibrations in the first torque transmission path 47 relative to the second torque transmission path 47. The coupling arrangement 51 of the torsional vibration damping arrangement 10 is constructed as a magnetic coupling gear unit 61 which operates similar to a known planetary gear unit. In the embodiment shown here, an external rotor 21 is located radially outwardly and is formed radially inwardly with permanent magnets 22; 23 which are shown more clearly in FIG. 2. An internal rotor 31 is located radially inwardly and is configured radially outwardly also with permanent magnets 32; 33, shown more clearly in FIG. 2. A modulator ring 41 having ferromagnetic segments and nonmagnetic segments 42; 43 alternately in circumferential direction, shown more clearly in FIG. 2, is arranged between the external rotor 21 and the internal rotor 31.

The construction in FIG. 1 is intended as an example, particularly as concerns the dimensions and the quantity of the different magnet pairs and the segments in the modulator ring 41. In a practical implementation, the ferromagnetic elements 42 of the modulator would be also preferably be embedded in a closed supporting construction for reasons of strength instead of the various segments merely being joined to one another in circumferential direction as is shown here. However, this is known from the art. The same also applies to the fastening of the permanent magnets 22, 23, 32; 33 to the rotors.

Magnetic fields are generated by the magnet arrangements 22; 23 and 32; 33, respectively. The quantity of magnets in the two arrangements is coordinated in such a way that the magnetic fields do not mutually influence one another without the modulator ring 41. As a result of the quantity and arrangement of the ferromagnetic segments 42 of the modulator ring 41, however, the magnetic fields are modulated in such a way that a magnetic coupling takes place between the internal rotor 31 and the external rotor 21. The mathematical-physical relationships for determining the required quantity of magnet pairs at the internal rotor and external rotor and of the ferromagnetic elements 42 of the modulator ring 41 have long been known in the art and need not be discussed further. However, it should be noted that a large range of gear ratios is possible between the three gear unit elements as a result of an appropriate configuration, that this is determined only by the ratios of the quantity of magnet pairs and modulator segments and that, for each quantity of pole pairs of the two rotors 21;31, two different numbers of modulator segments 42; 43 are possible by which a different rotational direction of the modulator ring 41 is achieved with respect to one of the other rotors 21; 31.

In terms of its basic functioning, a magnetic coupling gear unit 61 of this type works similar to a planetary gear unit which is previously known from the prior art for torsional vibration damping arrangements with two torque transmission paths. Accordingly, it is also possible to use it as a coupling arrangement 51 for the torsional vibration damping arrangement 10 with two torque transmission paths. This has various advantages. For one, the magnetic coupling gear unit 61 can be operated free of lubricant, since the gear unit elements 21; 31; 41 do not touch each other. Additionally, the magnetic coupling gear unit 61 operates free from wear and virtually free from noise except for the noise brought about by a bearing support of the gear unit elements 21; 31; 41. The magnetic coupling gear unit 61 is also safeguarded against overload because it merely slips comparable to a stepper motor without sustaining damage when a maximum torque is exceeded. A larger number of connection variants of the torsional vibration damping arrangement 10 with two torque transmission paths is also made possible owing to the fact that the gear ratios can be adjusted very flexibly and independently from the radii of the gear unit elements 21; 31; 41 in magnetic gear units, as in the magnetic coupling gear unit 61 shown herein, and owing to the rotational direction of the modulator ring 41 being adjustable independently from the gear ratio.

FIG. 2 shows a constructional layout of a magnetic coupling gear unit 61. The gear unit comprises the external rotor 21 which has on its inner side permanent magnets 22; 23 which alternately have a magnetic north polarity 22 and a magnetic south polarity 23. An internal rotor 31 which likewise has permanent magnets 32; 33 with alternating polarity is arranged radially inwardly.

A modulator ring 41 alternately having ferromagnetic segments 42 and nonmagnetic segments 43 is located radially between the two rotors or magnet arrangements. The manner of functioning is the same as that already described referring to FIG. 1.

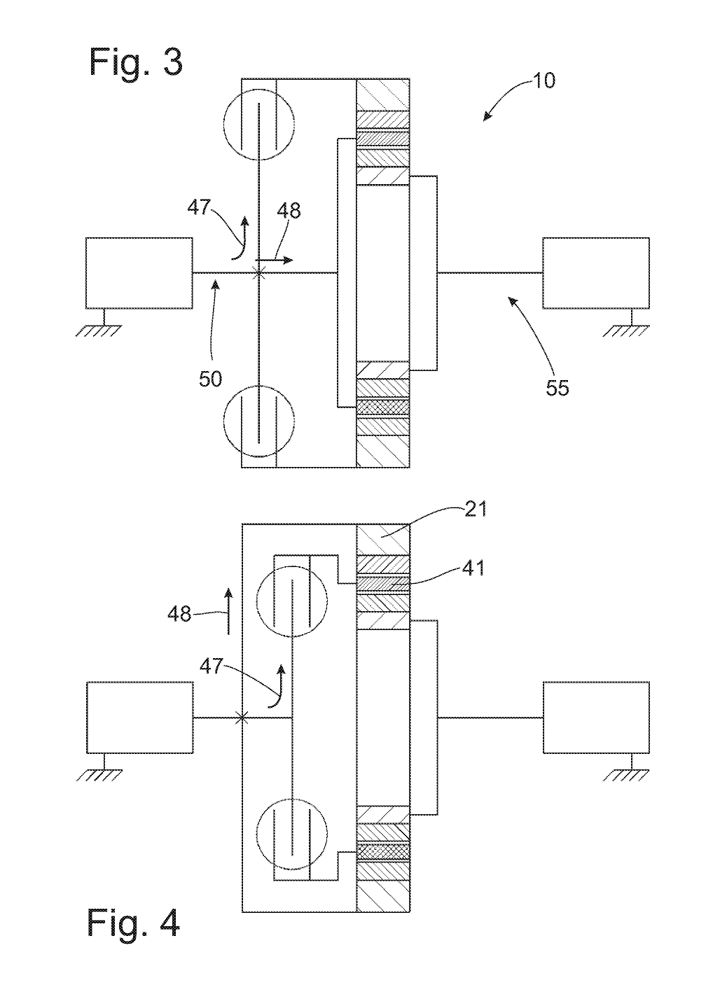

In addition to the connection variants of the torsional vibration damping arrangement 10 already shown in FIG. 1, FIGS. 3 to 7 show various other possibilities for connecting the individual elements 21; 31; 41 of the magnetic coupling gear unit 61 to the two torque transmission paths 47; 48 and to the output region 55.

Although all of these connection variants are possible in principle, the connection variants shown in FIG. 3 and FIG. 4 are particularly advantageous because, in this case, a high mass moment of inertia of the outer rotor 21 is associated with the secondary element 2 of the phase shifter arrangement 44.

The inventive ideas mentioned in the following are described only with reference to the arrangement in FIG. 3 but also apply analogously to the other possible connections.

FIG. 3 schematically shows a torsional vibration damping arrangement 10 with two torque transmission paths 47; 48 and a magnetic coupling gear unit 61 as coupling arrangement 51 for the two torque transmission paths 47; 48. In this case, in contrast to the connection variants in FIG. 1, the output region 55 is connected to the internal rotor 31 and the modulator ring 41 is connected to the second torque transmission path 48.

In FIG. 4, in contrast to FIG. 3, the first torque transmission path 47 is connected to the modulator ring 41, and the second torque transmission path 48 is connected to the external rotor 21.

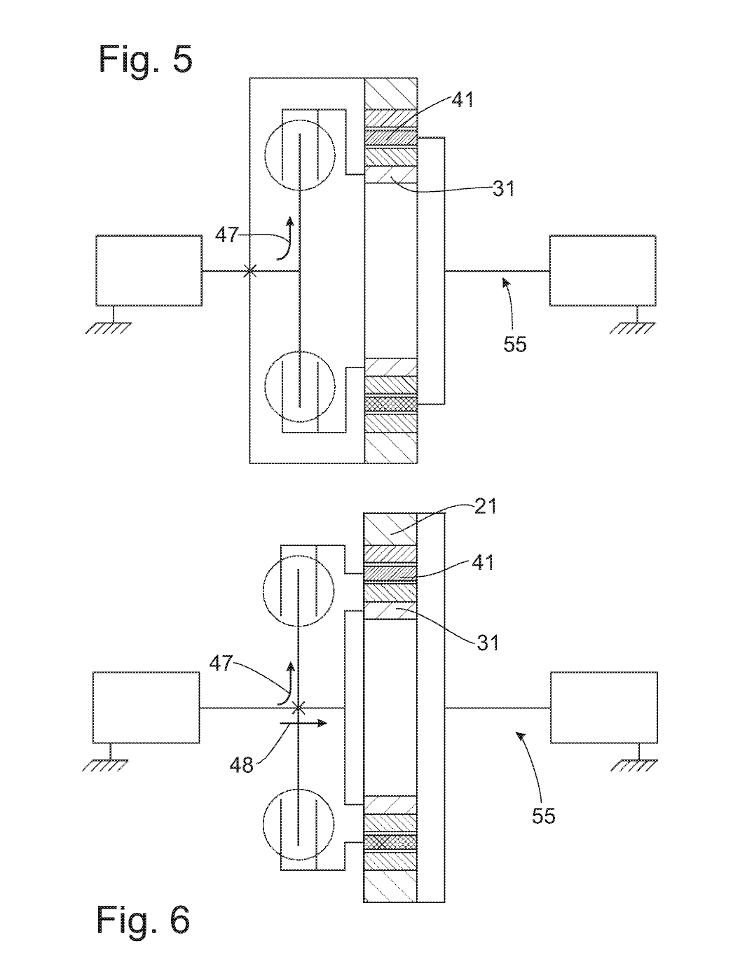

In FIG. 5, in contrast to FIG. 4, the first torque transmission path 47 is connected to the internal rotor 31, and the modulator ring 41 is connected to the output region 55.

FIG. 6 shows a connection variant in which the external rotor 21 is connected to the output region 55, the first torque transmission path 47 is connected to the modulator ring 41, and the second torque transmission path is connected to the internal rotor 31.

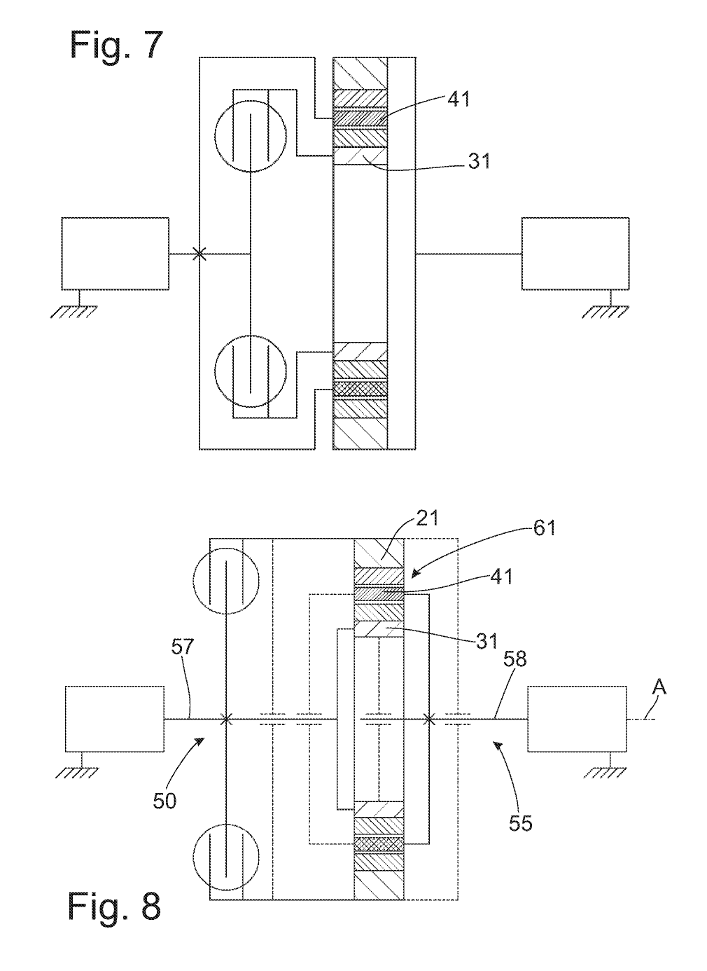

In FIG. 7, in contrast to FIG. 6, only the connections for the internal rotor 31 and the modulator ring are exchanged.

FIG. 8 shows a radial bearing support variant of the magnetic coupling gear unit 61. In this case, the external rotor 21 is radially supported on a shaft 58 which is associated with output region 55. This shaft 58 can be a transmission input shaft, for example. Further, the internal rotor 31 is likewise supported on the shaft 58. The modulator ring 41 and the phase shifter arrangement are radially supported on the shaft 57 which is associated with the input region 50 and which can be a crankshaft, for example.

In another variant, not shown, the radial bearing support in its entirety can also be carried out on shaft 57 or on shaft 58. This can be advantageous because a possible misalignment of the transmission input shaft with respect to the crankshaft is avoided and a concentric running of the component parts around the rotational axis A is improved. Accordingly, an air gap between the external rotor 21 and the modulator ring 41 and between the modulator ring 41 and the internal rotor 31 can be minimized, which is advantageous for the magnetic forces between the gear unit elements.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-14. (canceled)

15. A torsional vibration damping arrangement for a powertrain of a vehicle, comprising:
an input region to be driven for rotation around a rotational axis (A);
an output region; and parallel to one another between the input region and the output region, a first torque transmission path for transmitting a first torque component (Mₐ₁) of a total torque (M_{ges}) to be transmitted between the input region and the output region and a second torque transmission path for transmitting a second torque component (Mₐ₂) of the total torque (M_{ges}) to be transmitted between the input region and the output region;
a phase shifter arrangement disposed at least in the first torque transmission path for generating a phase shift of rotational irregularities conducted via the first torque transmission path in relation to rotational irregularities conducted via the second torque transmission path, wherein the phase shifter arrangement comprises a vibration system with a primary element and a secondary element which is rotatable relative to the primary element around the rotational axis (A) against a restoring action of a damper element arrangement;
a coupling arrangement for combining the first torque component (Mₐ₁) which is transmitted via the first torque transmission path and the second torque component (Mₐ₂) which is transmitted via the second torque transmission path and for routing the combined torque (Mₐᵤₛ) to the output region, wherein the coupling arrangement comprises a first input element connected to the first torque transmission path, a second input element connected to the second torque transmission path, and an output element connected to the output region; and the coupling arrangement being constructed as a magnetic coupling gear unit.

16. The torsional vibration damping arrangement according to claim 15, wherein the magnetic coupling gear unit includes an external rotor, an internal rotor arranged concentric to the external rotor, and a modulator ring arranged concentrically radially between the external rotor and the internal rotor, and wherein the external rotor, internal rotor and modulator ring are arranged so as to at least partially axially overlap one another.

17. The torsional vibration damping arrangement according to claim 15, wherein the external rotor comprises a radially inner side and permanent magnets which have a magnetic north polarity and a magnetic south polarity alternately in circumferential direction, or the external rotor being formed at the radially inner side with permanent magnets which have a magnetic north polarity and a magnetic south polarity alternately in circumferential direction.

18. The torsional vibration damping arrangement according to claim 15, wherein the internal rotor comprises a radially outer side and permanent magnets having a magnetic north polarity and a magnetic south polarity alternately in circumferential direction, or in that the internal rotor is formed at the radially outer side with permanent magnets (32; 33) having a magnetic north polarity and a magnetic south polarity alternately in circumferential direction.

19. The torsional vibration damping arrangement according to claim 15, wherein the modulator ring comprises ferromagnetic segments and nonmagnetic segments arranged alternately in circumferential direction.

20. The torsional vibration damping arrangement according to claim 15, wherein the external rotor is connected to the first input element, and the internal rotor is connected to the second input element, and the modulator ring is connected to the output element.

21. The torsional vibration damping arrangement according to claim 15, wherein the external rotor is connected to the second input element, and the modulator ring is connected to the first input element, and the internal rotor is connected to the output element.

22. The torsional vibration damping arrangement according to claim 15, wherein the external rotor is connected to the first input element, and the modulator ring is connected to the second input element, and the internal rotor is connected to the output element.

23. The torsional vibration damping arrangement according to claim 15, wherein the external rotor is connected to the second input element, and the modulator ring is connected to the output element, and the internal rotor is connected to the first input element.

24. The torsional vibration damping arrangement according to claim 15, wherein the external rotor is connected to the output element, and the modulator ring is connected to the first input element, and the internal rotor is connected to the second input element.

25. The torsional vibration damping arrangement according to claim 15, wherein the external rotor is connected to the output element, and the modulator ring is connected to the second input element, and the internal rotor is connected to the first input element.

26. The torsional vibration damping arrangement according to claim 15, wherein the external rotor and the modulator ring and the internal rotor are rotatably supported at a shaft which is concentric to the rotational axis (A) and which communicates with the input region.

27. The torsional vibration damping arrangement according to claim 15, wherein the external rotor and the modulator ring and the internal rotor are rotatably supported at a shaft which is concentric to the rotational axis (A) and which communicates with the output region.

28. The torsional vibration damping arrangement according to claim 15, wherein at least the external rotor or the modulator ring or the internal rotor is rotatably supported at a shaft which is concentric to the rotational axis (A) and communicates with the input region; and wherein at least the external rotor or the modulator ring or the internal rotor is rotatably supported at a shaft which is concentric to the rotational axis (A) and communicates with the output region.
